(19) United States
(12) Patent Application Publication
(10) Pub. No.: US 2006/0125276 A1
(43) Pub. Date: Jun. 15, 2006

(54) Fixture structure for automobile electronic sun shield

(76) Inventor: Chien-Yuan Chen, Banchiau City (TW)

Correspondence Address: Power Digital Communications Co., Ltd., P. O. Box No. 6-57, Junghe, Taipei, 235, TW

(21) Appl. No.: 11/007,321

(22) Filed: Dec. 9, 2004

(51) Int. Cl. B60J 3/00

(52) U.S. Cl. 296/97.6

(57) ABSTRACT

A fixture structure of an automobile electronic sun shield, and more particularly relates to the fixture structure of the added electronic sun shield to the original sun shield, with the fixture structure implemented at the opposite locations of the two sides of the electronic sun shield. The fixture structure includes a bearing, an adjusting bolt, a rail piece, a through piece, and a clip piece. By conditioning the adjusting bolt and the rail piece to control the displacement of the clip piece, the pitch of the opposite clips pieces can be adjusted in order to clip the electronic sun shield onto the original sun shield.

### BACKGROUND OF THE INVENTION

a) Field of the Invention

The present invention relates to a fixture structure for an automobile electronic sun shield, and more particularly to a fixture structure for an electronic sun shield that is added to an automobile sun shield, mainly by matching of screwthread of an adjusting bolt with feed holes of a rail piece, to serve as the structure for adjusting displacement, thereby controlling the movement of clip pieces to provide rigid fastening of the added electronic sun shield onto the original sun shield.

b) Description of the Prior Art

A sun shield is used by drivers as one of the apparatus to shield against direct sun light. Therefore, manufacturers of automobile components have developed a kind of electronic sun shields that can display electronic maps, play video and audio media, or perform PDA-related functions, to greatly promote the function of providing driving information or entertainment.

Accordingly, it is one of the inventor's top duties to design a fixture method to add an electronic sun shield to a conventional sun shield.

In general, the fixture method can be divided into latching, adhesion, adsorption, or clipping method. However, the latching method requires the destroy of the surface of object to be fixed, and cannot be restored; the adhesion method requires the use of adhesives for fixing, and the adhesives will still be attached on the surface after restoring; for the adsorption method, the adhesive force still remains to be justified, due to the decreasing of the adhesive force by the oxidation of colloid resulting from high temperature due to the long term exposure to the sun light.

Therefore, only the clipping method will lastly destroy the body of original sun shield, without having the difficulty of cleaning up the residuals of colloid. Accordingly, the inventor has designed a fixture structure for an electronic sun shield that can be easily implemented and without the shortcoming of conventional methods.

### SUMMARY OF THE INVENTION

The primary object of the present invention is to provide a fixture structure that can be implemented to an added electronic sun shield, allowing consumers to easily assemble without dismantling any original component, mainly by the conditioning between an adjusting bolt and a rail piece to control the displacement of clip pieces, thereby adjusting the pitch of the opposite clip pieces to enable clipping onto the original sun shield.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a fixture structure of the present invention.

FIG. 2 shows a schematic view of a swivel structure of the present invention.

FIG. 3 shows a schematic view of the implementation of a fixture structure and a swivel structure on an electronic sun shield for the present invention.

FIG. 4 shows a schematic view of the implementation of an electronic sun shield inside an automobile for the present invention.

FIG. 5A shows a schematic view of usage operation of the present invention.

FIG. 5B shows another schematic view of usage operation of the present invention.

### DETAILED DESCRIPTION OF THE PREFERRED EMBODIMENTS

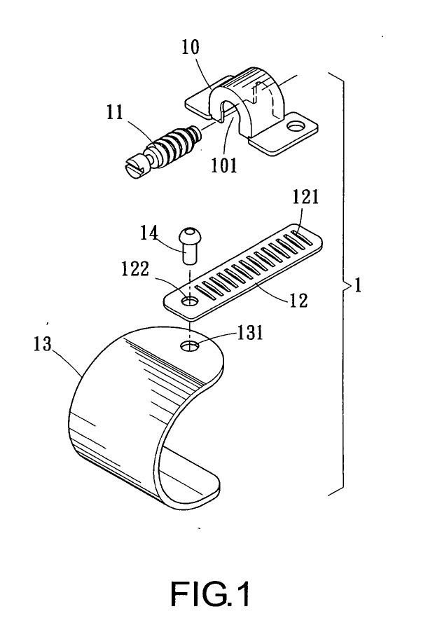

Referring to FIG. 1, the present invention refers to a fixture structure 1 of an added electronic sun shield to an original automobile sun shield. The fixture structure 1 comprises a bearing 10, an adjusting bolt 11, a rail piece 12, a through piece 14, and a clip piece 13. The bearing 10 is a reverse U-shape bearing with a center opening 101 for holding the adjusting bolt 11 that is equipped with screwthread and matching with multiple feed holes 121 on the rail piece 12 such that sliding displacement can be generated when swiveling the adjusting bolt 11. A through hole 122 is located at the end of the rail piece 12, allowing through piece 14 to insert into and get through a through hole 131 of a clip piece 13, thereby assembling the clip piece 13 and the rail piece 12 into a single unit, and thus the clip piece 13 will be moving with sliding movement of the rail piece 12, in order to adjust the clipping.

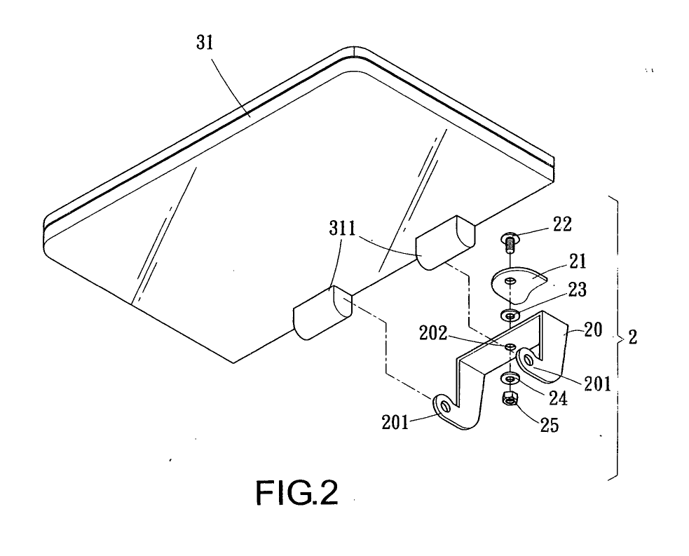

Referring to FIG. 2, it shows a schematic view of a swivel structure 2 and an electronic screen 31. The swivel structure 2 comprises a reverse U-shape frame 20 with two connecting ears 201 at two sides to fix with fixture part 311 of the electronic screen 31. A through hole 202 is located at the center of the reverse U-shape frame 20, allowing bolt 22 to get through a fixture seat 21, gaskets 23 and 24, and a latching screw 25. The swivel structure 2 is located between the electronic sun shield and the electronic screen 31, in order to adjust the rotational and inclination angle of the electronic screen 31.

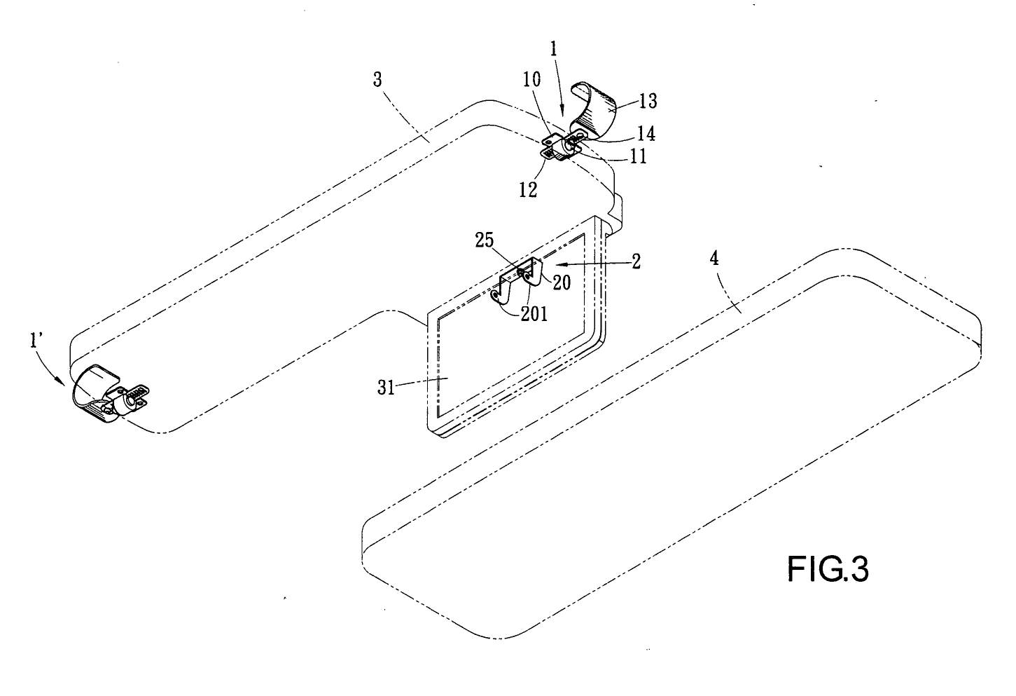

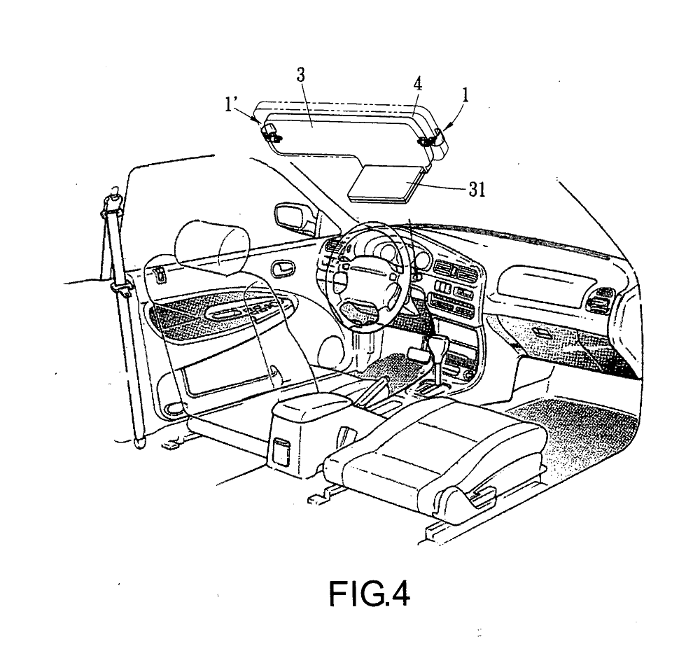

Referring to FIG. 3 and FIG. 4, it shows that the fixture structure 1 and 1′ are implemented at the opposite locations of the two sides of the electronic screen 31, and with the conditioning of the adjusting bolt 11 and the rail piece 12 of the fixture structure 1 to control the displacement of the clip piece 13, thereby adjusting the pitch of the opposite clip pieces to enable the clipping onto the original sun shield 4. Moreover, the swivel structure 2 is located between the electronic sun shield and the electronic screen 31, to adjust the rotational and inclination angle of the electronic screen 31.

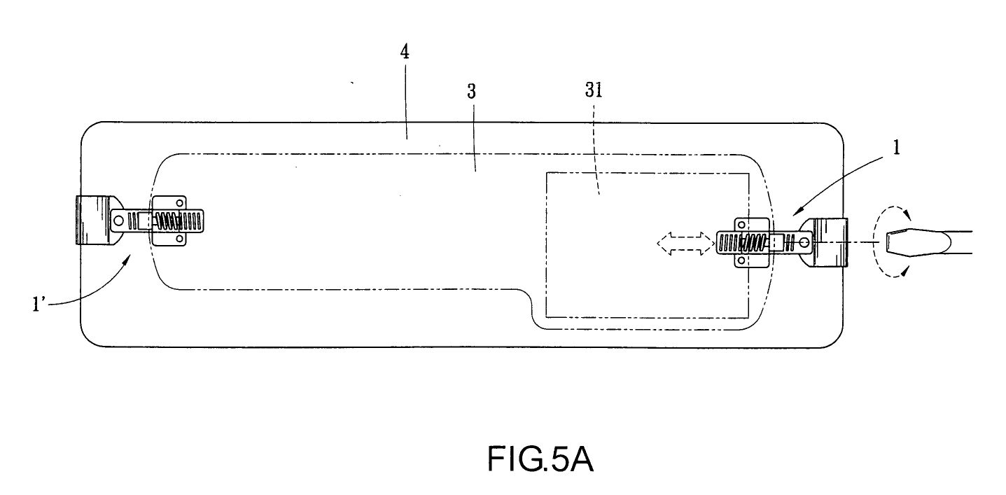

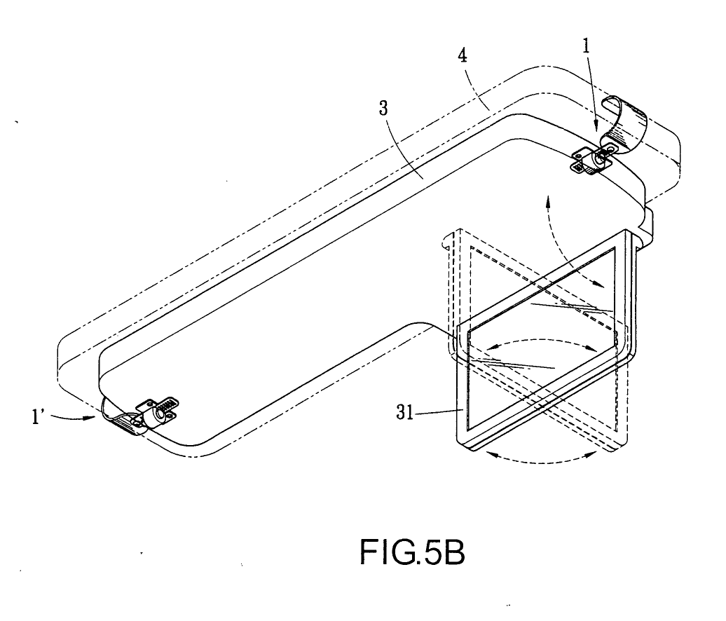

Referring to FIG. 5A and FIG. 5B, operators can use a Phillips screwdriver to apply at the adjusting bolt 11 to adjust the rail piece 12, in order to control the distance between the clip pieces 13, thereby clipping the electronic sun shield 13 onto the original sun shield 14. Moreover, the swivel structure 2 is used to connect the electronic screen 31, and thus providing the electronic screen 31 with the capability of rotating and inclining, in order to fit with the viewing angle of drivers.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A fixture structure of an automobile electronic sun shield having a fixture structure implemented at the opposite locations of the two sides of the electronic screen comprising:
a bearing, which is a reverse U-shape frame with a central opening for holding an adjusting bolt;
an adjusting bolt with screwthread, which is located at the center of the bearing and matching with feed holes of a rail piece;
the rail piece with multiple feed holes, such that sliding displacement can be generated when swiveling the adjusting bolt;
a clip piece used for clipping;
a through piece used for fixedly getting through the rail piece and the clip piece;
by conditioning of the adjusting bolt and the rail piece to control the displacement of the clip pieces, in order to adjust the pitch of the opposite clip pieces, thereby clipping the electronic sun shield onto the original sun shield.
